(19) United States
(12) Patent Application Publication
(10) Pub. No.: US 2011/0004615 A1
(43) Pub. Date: Jan. 6, 2011

(54) SYSTEM FOR AND METHOD OF DISTRIBUTING DEVICE INFORMATION IN AN INTERNET PROTOCOL MULTIMEDIA SUBSYSTEM (IMS)

(75) Inventor: Raymond C. COUNTERMAN, Canton, MA (US)

Correspondence Address: VERIZON;PATENT MANAGEMENT GROUP, 1320 North Court House Road, 9th Floor, ARLINGTON, VA, 22201-2909, US

(73) Assignee: VERIZON PATENT AND LICENSING, Basking Ridge, NJ (US)

(21) Appl. No.: 12/497,775

(22) Filed: Jul. 6, 2009

(51) Int. Cl. G06F 17/30; G06F 17/00

(52) U.S. Cl. 707/769; 707/759; 707/912; 707/955; 707/778

(57) ABSTRACT

A system for and method of distributing device information in an Internet Protocol Multimedia Subsystem (IMS) is presented. The system and method may include storing at least one of public identification information and device identification information associated with an end-user device. The system and method may also include receiving, from an application system, a query for device information associated with the end-user device via a network. The system and method may further include retrieving, from a device database, the device information based on the query. The system and method may yet further include outputting, to the application system, the retrieved device information.

### BACKGROUND INFORMATION

In general, an application providing a service to an end-user device in a network may utilize device information associated with the end-user device to provide the service. Device information may be provided to the application by the end-user device in response to a request for the device information from the application. Network systems that provide device information to applications in such a manner may be improved.

### BRIEF DESCRIPTION OF THE DRAWINGS

The present invention, together with further objects and advantages, may best be understood by reference to the following description taken in conjunction with the accompanying drawings, in the several figures of which like reference numerals identify like elements, and in which:

FIG. 1 is a schematic diagram illustrating a system according to a particular embodiment;

FIG. 2 is a schematic diagram illustrating exemplary modules of a device application server according to a particular embodiment;

FIG. 3 is a schematic diagram illustrating the relationship between various identification information according to a particular embodiment;

FIG. 4 is a schematic diagram illustrating a device service information process according to a particular embodiment;

FIG. 5 is a schematic diagram illustrating another device service information process according to a particular embodiment;

FIG. 6 is a schematic diagram illustrating another device service information process according to a particular embodiment;

FIG. 7 is a schematic diagram illustrating another device service information process according to a particular embodiment; and

FIG. 8 is a flowchart illustrating the functionality of a particular embodiment.

### DETAILED DESCRIPTION OF PREFERRED EMBODIMENTS

A device information system may be configured to provide device information associated with an end-user device (e.g., a set top box, a Voice over Internet Protocol (VoIP) device, a personal computer (PC), an analog terminal adaptor (ATA), a mobile phone) to a network available application using a device application server that is communicatively coupled to one or more device databases. Device information may include data that indicates one or more characteristics of an end-user device. For example, device information may indicate one or more types of codecs supported by the end-user device. An application that receives device information may include any software that is configured to provide a service to an end-user device using a network. For example, an application may include software that is configured to provide instant message services to an end-user device using a network.

A device application server may provide device information associated with an end-user device to a network available application such that the application is enabled to efficiently provide a service to the end-user device. For example, an application configured to provide video content to an end-user device may receive device information that indicates that the end-user device is able to render an image of at a particular resolution (e.g., N by M pixels). Accordingly, the application may process the video content such that the video content is optimized for display on the end-user device at a resolution of N by M pixels.

In one embodiment, the device information system may provide the device application server with device identification information associated with a plurality of end-user devices during a registration process. Accordingly, the device application server may use the device identification information to retrieve device information associated with the plurality of end-user devices from one or more device databases. For example, device application server may retrieve device information associated with an end-user device from a device database in response to a query from an application. Based on device identification information provided in the query, the device application server may retrieve the requested device information from one or more device databases.

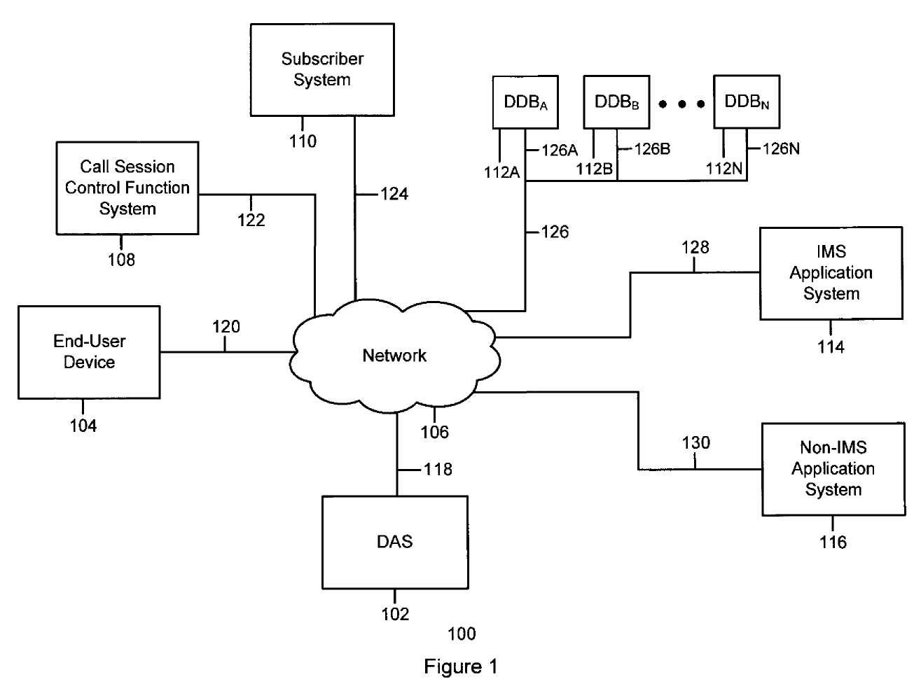

FIG. 1 is a schematic diagram illustrating a system according to a particular embodiment. Device information system 100 may communicatively couple together any, or a combination, of a device application server (DAS) 102, an end-user device 104, a Call Session Control Function system (CSCF) 108, a subscriber system 110, one or more device databases (DDB) 112A, 112B, 112N, an IMS application system 114, and a non-IMS application system 116, using network 106. Accordingly, data signals may be transmitted to any of the components of device information system 100 and transmitted from any of the components of device information system 100 using network 106. For example, device information data signals, device identification information data signals, public identification information data signals, private user identification information data signals, or query data signals may be transmitted to any of the components of device information system 100 and transmitted from any of the components of device information system 100 using network 106.

Network 106 may be a wireless network, a wired network or any combination of wireless network and wired network. For example, network 106 may include one or more of a fiber optics network, a passive optical network, a cable network, an Internet network, a satellite network (e.g., operating in Band C, Band Ku, or Band Ka), a wireless local area network (LAN), a Global System for Mobile Communication (GSM), a Personal Communication Service (PCS), a Personal Area Network (PAN), D-AMPS, Wi-Fi, Fixed Wireless Data, IEEE 802.11a, 802.11b, 802.15.1, 802.11n and 802.11g or any other wired or wireless network for transmitting and/or receiving a data signal. In addition, network 106 may include, without limitation, a telephone line, fiber optics, IEEE Ethernet 802.3, a wide area network (WAN), a LAN, or a global network such as the Internet. Also, network 106 may support, an Internet network, a wireless communication network, a cellular network, or the like, or any combination thereof. Network 106 may further include one, or any number of the exemplary types of networks mentioned above operating as a stand-alone network or in cooperation with each other. Network 106 may utilize one or more protocols of one or more network elements to which it is communicatively coupled. Network 106 may translate to or from other protocols to one or more protocols of network devices. Although network 106 is depicted as one network, it should be appreciated that according to one or more embodiments, network 106 may comprise a plurality of interconnected networks, such as, for example, a service provider network, the Internet, a broadcaster's network, a cable television network, corporate networks, and home networks.

DAS 102, end-user device 104, CSCF system 108, subscriber system 110, DDBs 112A, 112B, 112N, IMS application system 114, and non-IMS application system 116, may transmit and receive data to and from network 106 representing device information, device identification information, public identification information, private identification information, query data, and other data. The data may be transmitted and received utilizing a standard telecommunications protocol or a standard networking protocol. For example, one embodiment may utilize Session Initiation Protocol (SIP). In other embodiments, the data may be transmitted and/or received utilizing other VoIP or messaging protocols. For example, data may also be transmitted and/or received using Wireless Application Protocol (WAP), Multimedia Messaging Service (MMS), Enhanced Messaging Service (EMS), Short Message Service (SMS), Global System for Mobile Communications (GSM) based systems, Code Division Multiple Access (CDMA) based systems, Transmission Control Protocol/Internet (TCP/IP) Protocols, or other protocols and systems suitable for transmitting and receiving data. Data may be transmitted and received wirelessly or may utilize cabled network or telecom connections such as: an Ethernet RJ45/Category 5 Ethernet connection, a fiber connection, a traditional phone wireline connection, a cable connection, or other wired network connection. Network 106 may use standard wireless protocols including IEEE 802.11a, 802.11b and 802.11g. Network 106 may also use protocols for a wired connection, such as an IEEE Ethernet 802.3.

The end-user device 104 may be communicatively coupled to network 106 via data path 120. The end-user device 102 may include, but is not limited to, a computer device or communications device including, e.g., a personal computer (PC), a workstation, a mobile device, a handheld PC, a thin system, a fat system, a network appliance, an Internet browser, a server, a lap top device, a set top box, a VoIP device, an ATA, a video server, a Public Switched Telephone Network (PSTN) gateway, a Mobile Switching Center (MSC) gateway, or any other device that is configured to store private user identification information, public identification information, device credential information, and device identification information, authenticate with the CSCF system 108 via data path 120, receive one or more services provided by one or more applications associated with the IMS application system 114 via data path 120, and receive one or more services provided by one or more applications associated with the non-IMS application system 116 via data path 120.

The end-user device 104 may be configured to authenticate with the CSCF system 108 using device credential information stored in the end-user device 104. Device credential information may include data that may be used to verify the identification of a particular end-user device. For example, device credential information may include any, or a combination, of a secret key (e.g., a shared secret key), private user identification information (e.g., identification information associated with a particular user of an end-user device), device identification information, a digital certificate, a user name, and a password. In one embodiment, the end-user device 104 may be configured to authenticate with the CSCF system 108 during a registration process (discussed below).

The CSCF system 108 may be communicatively coupled to network 106 via data path 122. The CSCF system 108 may provide one or more call session control functions (CSCFs) in accordance with one or more well-known standards, such as the 3^{rd} Generation Partnership Project (3GPP) IP Multimedia Subsystem (IMS) standards. Accordingly, a call session control function may include any, or a combination, of the proxy call session control function (P-CSCF), the serving call session control function (S-CSCF), and the interrogating call session control function (I-CSCF) of the 3GPP standards.

The CSCF system 108 may be configured to authenticate the end-user device 104 during a registration process, such as an IMS registration process. An IMS registration process may include a systematic series of actions directed to authenticating the end-user device 104 with the device information system 100 and associating the end-user device 104 with any, or a combination, of device identification information, private user identification information, and public identification information.

During the IMS registration process, the end-user device 104 may transmit an authentication initiation message to the CSCF system 108 to initiate the authentication process. In response to receipt of the authentication initiation message, the CSCF system 108 may access (e.g., download, retrieve) authentication data (e.g., random number (RAND and sequence number (SQN)) and expected result data (e.g., data that is an output of an authentication algorithm such as: the Authentication and Key Agreement (AKA) algorithm or the expected response (XRES)). The CSCF system 108 may challenge the end-user device 104 to authenticate based on the authentication data. The end-user device 104 may then transmit an authentication message to CSCF system 108 to authenticate. The authentication message may include any, or a combination, of device identification information, private user identification information, and the resulting output (RES) from processing the authentication data using the same authentication algorithm.

Based on the information provided in the authentication message, the CSCF system 108 may determine whether to authenticate the end-user device 104 to the device information system 100 (e.g., if XRES=RES). If, for example, the CSCF system 108 determines not to authenticate the end-user device 104 to the device information system 100, the end-user device 104 may be treated as an unregistered device. If, however, the CSCF system 108 determines to authenticate the end-user device 104 to the device information system 100, the end-user device 104 may be treated as a registered device and may receive additional identification information (e.g., public identification information) from the CSCF system 108 in a successful registration message.

In one embodiment, the successful registration message may be transmitted to the end-user device 104 in a protocol header portion of a data packet. For example, the successful registration message may be transmitted in the protocol header portion called P-Associated-URI header. An associated Uniform Resource Identifier (URI) may include public identification information (e.g., a public user identity) that an implementer of the device information system 100 (e.g., a service provider) assigns to a particular user's service subscription. In one embodiment, the CSCF system 108 may transmit device identification information to the end-user device 104 in the successful registration message as an associated URI in the following format: Device_ID@URI. The CSCF system 108 may receive the additional identification information provided in the successful registration message from the subscriber system 110.

Accordingly, at the end of a first portion (e.g., first phase) of a registration process, the CSCF system 108 may have access to at least one public user identity associated with the end-user device 104 that may be used to set up one or more communication sessions with the end-user device 104. In addition, the CSCF system 108 may have access to the end-user device's 104 device identification information (e.g., a device identity) that is associated with at least one registered public user identity and the IP address of the end-user device 104.

A second portion (e.g., second phase) of a registration process may include the CSCF system 108 notifying one or more subscribing application systems (e.g., an application system that has subscribed to receive a service provided by a CSCF system such that the application system is automatically notified of new end-user device registrations and end-user device de-registrations), such as IMS application system 114 and non-IMS application system 116, of the existence of a plurality of registered public user identities (e.g., that may be associated with a plurality of registered end-user devices). Further, the CSCF system 108 may provide the IMS application system 114 and non-IMS application system 116 with information that the IMS application system 114 and non-IMS application system 116 may use to communicate with the end-user device 104. Such information may include the Device_ID@URI associated with an end-user device 104.

It should be noted that the second phase of the registration process may utilize one or more features of the Session Initiation Protocol (SIP). For example, the second phase of the registration process may utilize a SUBSCRIBE feature, a NOTIFY feature, and an event package feature for registration as defined by SIP.

The subscriber system 110 (e.g., a home subscriber server) may be communicatively coupled to network 106 via data path 124. The subscriber system 110 may include, but is not limited to, a computer device or communications device including, e.g., a personal computer (PC), a workstation, a mobile device, a handheld PC, a thin system, a fat system, a network appliance, a server, a lap top device, or any other device that is configured to store private user identification information, public identification information (e.g., a public user identity), device credential information, and device identification information in the form of Device_ID@URI and provide the CSCF system 108 with public identification information and device identification information in the form of Device_ID@URI via data path 124.

An implementer of the device information system 100 (e.g., a service provider) may provision any, or a combination, of the subscriber system 110 and the end-user device 104 with private user identification information, public identification information (e.g., a public user identity), device credential information, and device identification information in the form of Device_ID@URI associated with a plurality of end-user devices at the time of service subscription. Accordingly, during a registration process, the subscriber system 110 may provide the CSCF system 108 with public identification information and device identification information in the form of Device_ID@URI associated with the subscribing end-user devices.

Device databases 112A, 112B, 112N may be communicatively coupled to network 106 via data path 126. For example, device database 112A may be communicatively coupled to network 106 via data path 126A. In another example, device database 112B may be communicatively coupled to network 106 via data path 126B. In yet another example, device database 112N may be communicatively coupled to network 106 via data path 126N.

Device databases 112A, 112B, 112N may be network accessible storage and may be local, remote, or a combination thereof to DAS 102. Device databases 112A, 112B, 112N may utilize a redundant array of inexpensive disks (RAID), tape, disk, a storage area network (SAN), an internet small computer systems interface (iSCSI) SAN, a Fibre Channel SAN, a common Internet File System (CIPS), a network attached storage (NAS), a network file system (NFS), or other computer accessible storage. In one embodiment, device databases 112A, 112B, 112N may be a database, such as an Oracle database, a Microsoft SQL Server database, a DB2 database, a MySQL database, a Sybase database, an object oriented database, a hierarchical database, or other database. Device databases 112A, 112B, 112N may utilize flat file structures for storage of data.

Device databases 112A, 112B, 112N may be configured to store device information associated with a plurality of end-user devices. Device information may include data that indicates one or more characteristics of an end-user device. For example, device information may indicate one or more types of codecs supported by an end-user device, rendering capabilities of an end-user device, one or more technical capabilities of an end-user device, product data of an end-user device, one or more types of software supported by an end-user device, one or more types of applications supported by the end-user device, one or more versions of the end-user device, or any other information associated with an end-user device. In one embodiment, the device databases 112A, 112B, 112N may store device information associated with an end-user device according to the device identification information associated with the end-user device. Accordingly, the device databases 112A, 112B, 112N may be provisioned with device information associated with a plurality of end-user devices and corresponding device identification information for each end-user device at the time of service subscription.

In one embodiment, the device databases 112A, 112B, 112N may be configured to receive updated device information associated with one or more end-user devices. For example, a service provider may upgrade the capabilities of an end-user device or configure new features of a end-user device (e.g., by downloading an application to the end-user device for a new video telephony capability). Accordingly, the device databases 112A, 112B, 112N may update the device information associated with the upgraded end-user device to reflect the upgrade in capabilities.

In one embodiment, device databases 112A, 112B, 112N may be associated with at least one device type. In one embodiment, device databases 112A, 112B, 112N may be associated with one or more of the following device types: a set top box device type, a Voice over Internet Protocol (VoIP) device type, a Personal Computer (PC) device type, an Analog Terminal Adaptor (ATA) device type, a mobile phone device type, a Mobile Switching Center (MSC) device type, and a Public Switched Telephone Network (PSTN) device type. Accordingly, device databases 112A, 112B, 112N may store device information associated with a plurality of end-user devices of the device type of the device database. In one embodiment, device databases 112A, 112B, 112N may be associated with at least one manufacturer. Accordingly, device databases 112A, 112B, 112N may store device information associated with a plurality of end-user devices manufactured by the manufacturer associated with the device database. Device databases 112A, 112B, 112N may be configured to provide access to one or more systems, such as DAS 102 to retrieve device information.

IMS application system 114 may be communicatively coupled to network 106 via data path 128. IMS application system 114 may include, but is not limited to, a computer device or communications device including, e.g., a personal computer (PC), a workstation, a mobile device, a handheld PC, a thin system, a fat system, a network appliance, a server, a lap top device, or any other device that is configured to provide one or more IMS services to one or more end-user devices using one or more IMS applications, receive public identification information (e.g., a public user identity) and associated device identification information in the form of Device_ID@URI from the CSCF system 108 during a registration process via data path 128, and transmit queries to the DAS 102 requesting device information associated with a particular end-user device via data path 128.

In one embodiment, an application of the IMS application system 114 may be configured to query the DAS 102 for device information each time an end-user device registers with the device information system 100 to ensure that device information remains up-to-date. The IMS application system 114 may query the DAS 102 by transmitting a query that includes device identification information associated with a particular end-user device.

In one embodiment, an application of the IMS application system 114 may be configured to delete device information associated with an unregistered end-user device (e.g., at the time of expiration of registration of an end-user device). If, for example, the unregistered end-user device re-registers, the IMS application system 114 may query the DAS 102 for updated device information associated with the re-registered end-user device.

Non-IMS application system 116 may be communicatively coupled to network 106 via data path 130. Non-IMS application system 116 may include, but is not limited to, a computer device or communications device including, e.g., a personal computer (PC), a workstation, a mobile device, a handheld PC, a thin system, a fat system, a network appliance, a server, a lap top device, or any other device that is configured to provide one or more non-IMS services to one or more end-user devices using one or more non-IMS applications, receive public identification information (e.g., a public user identity) and associated device identification information in the form of Device_ID@URI from external communication sources (not shown) that are associated with the end-user device prior to a registration process via data path 130, and transmit queries to the DAS 102 requesting device information associated with a particular end-user device via data path 130.

In one embodiment, an application of the non-IMS application system 116 may be configured to query the DAS 102 for device information to ensure that device information remains up-to-date. The non-IMS application system 116 may query the DAS 102 by transmitting a query that includes device identification information associated with a particular end-user device.

The DAS 102 may be communicatively coupled to network 106 via data path 118. The DAS 102 may include, but is not limited to, a computer device or communications device including, e.g., a personal computer (PC), a workstation, a mobile device, a handheld PC, a thin system, a fat system, a network appliance, a server, a lap top device, or any other device that is configured to receive public identification information (e.g., a public user identity) and associated device identification information in the form of Device_ID@URI from the CSCF system 108 (or the subscriber system 110) during a registration process via data path 118, receive queries requesting device information associated with a particular end-user device from the IMS application system 114 and the non-IMS application system 116, retrieve device information from the device databases 112A, 112B, 112N based on the received queries, and output device information to the IMS application system 114 or the non-IMS application system 116 in response to the queries via data path 118. Details of the DAS 102 are provided below.

One or more data paths disclosed herein may include any device that communicatively couples one or more devices to each other. For example, one or more data paths may include one or more wireless networks or one or more conductive wires (e.g., copper wires).

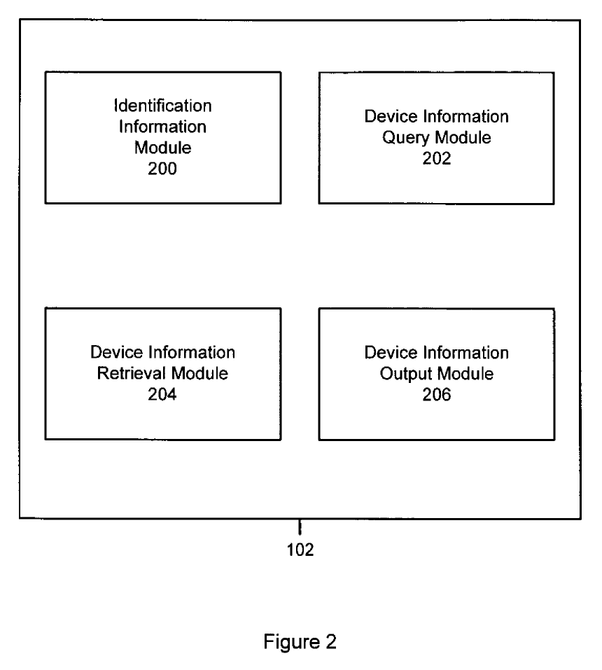

FIG. 2 is a schematic diagram illustrating exemplary modules of a device application server according to a particular embodiment. The DAS 102 may include an identification information module 200, a device information query module 202, device information retrieval module 204, and a device information output module 206. It is noted that the modules 200, 202, 204, and 206 are exemplary. The functions of the modules 200, 202, 204, and 206, may be performed at other modules remote or local to the DAS 102, and the modules 200, 202, 204, and 206 may be combined or separated.

The identification information module 200 may include any, or a combination, of software and hardware configured to receive public identification information (e.g., a public user identity) and associated device identification information in the form of Device_ID@URI from the CSCF system 108 (or the subscriber system 110). In one embodiment, the identification information module 200 may be configured to receive a public user identity and an associated Device_ID@URI associated with end-user device during a registration process such as, an IMS registration process.

The identification information module 200 may include any, or a combination, of software and hardware configured to store a public user identity and an associated Device_ID@URI. The identification information module 200 may store a public user identity and an associated Device_ID@URI that are associated with a plurality of end-user devices. For example, the identification information module 200 may be configured to store a first public user identity and an associated First_Device_ID@URI that are associated with a first end-user device (e.g., a mobile phone). In another example, the identification information module 200 may be configured to store a second public user identity and an associated Second_Device_ID@URI that are associated with a second end-user device (e.g., a set top box). In yet another example, the identification information module 200 may be configured to store a third public user identity and an associated Third_Device_ID@URI that are associated with a third end-user device (e.g., a VoIP device).

The device information query module 202 may include any, or a combination, of software and hardware configured to receive a query requesting device information. In one embodiment, the device information query module 202 may be configured to receive a query requesting device information associated with a particular end-user device, such as end-user device 104 from the IMS application system 114 or the non-IMS application system 116.

It should be noted that the device information system 100 may include multiple DASs. Accordingly, the query from an IMS application system 114 or the non-IMS application system 116 may be routed to a particular DAS (e.g., a DAS in the realm of the IMS application system 114 or the non-IMS application system 116) using the device identification information provided in the query.

The device information retrieval module 204 may include one or both of software and hardware configured to retrieve device information. In one embodiment, the device information retrieval module 204 may be configured to retrieve device information based on the device identification information provided in the query.

The device information retrieval module 204 may be configured to access one or more device databases 112A, 112B, 112N to retrieve the device information associated with the end-user device indicated in the device identification information. In one embodiment, the device information retrieval module 204 may execute one or more device database selection algorithms to determine which device database contains the device information requested. For example, the device information retrieval module 204 may execute a device database selection algorithm that determines which device database contains the device information requested based on the device types of the device databases 112A, 112B, 112N. In another example, the device information retrieval module 204 may execute a device database selection algorithm that determines which device database contains the device information requested based on the manufacturers of the end-user devices. In the absence of a device database selection algorithm, the device information retrieval module 204 may perform a sequential search of one or more of the device databases 112A, 112B, 112N to locate the requested device information.

The device information output module 206 may include any, or a combination, of software and hardware configured to output the retrieved device information. For example, the device information output module 206 may output retrieved device information to the IMS application system 114 in response to a query from the IMS application system 114. In another example, the device information output module 206 may output retrieved device information to the non-IMS application system 116 in response to a query from the non-IMS application system 116.

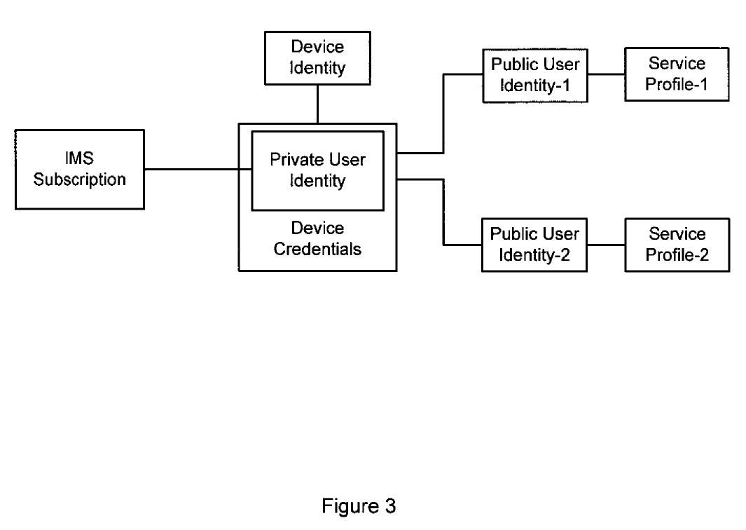

FIG. 3 is a schematic diagram illustrating the relationship between various identification information according to a particular embodiment. As illustrated in FIG. 3, in an IMS subscription process an end-user device, such as end-user device 104 may be associated with a private user identification information (e.g., a private user identity) and device credential information (e.g., one or more device credentials).

The private user identification information may include a private user identity (e.g., a private ID) that is a secret identity and associated with the end-user device. For example, the private ID may include an IMS private user identity (IMPI). The private ID may be permanently allocated to a user of the end-user device and stored in the end-user device.

In the IMS subscription process, the end-user device may also be associated with device identification information. Device identification information may include a device identity (ID) that is a unique device identifier. For example, a device ID may be include one or both of a publicly registered manufacturer identifier (e.g., an Organizationally Unique Identifier (OUI)) and an unique serial number of the end-user device provided by the manufacturer of the end-user device.

The string format for such a device ID may be following: OUI-SERIAL. The OUI may be defined as a six hexadecimal digit value in all upper case letters that includes any leading zeros. The OUI may include a valid OUI as defined by “IEEE Standards—Organizationally Unique Identifiers (OUI)” at http://standards.ieee.org/faqs/OUI.html, which is incorporated by reference herein in its entirety. The SERIAL may include a string that uniquely identifies an end-user device from a particular manufacturer. For example, a device ID associated with an end-user device in accordance with these techniques may include “00D09E-0123456789,” where the hexadecimal value “00D09E” is assigned to a particular manufacturer, such as Verizon Manufacturing Corporation.

The Device_ID@URI may include an expansion of the device ID in an URI format. Accordingly, the end-user device portion may include Device_ID while the hostport portion may include a Fully Qualified Domain Name (FQDN) of a DAS for a particular realm. In one embodiment, a well-known syntax may be defined as a prepended portion of the realm such that any application system in the realm is enabled to locate a DAS of the realm. For example, “00D09E-0123456789@device.ims.east.verizon.com” may include the prepended portion “ims.east.”

The public identification information may include one or more public Ids, such as Public User Identity-1 and Public User Identity-2. A public ID may include an address that is used to provide one or more services (e.g., Service Profile-1, Service Profile-2) to an end-user device, such as end-user device 104. For example, a public ID associated with an end-user device may be used in routing session management or signaling information to the end-user device. In one embodiment, the public ID may include an IMS public user identity (IMPU).

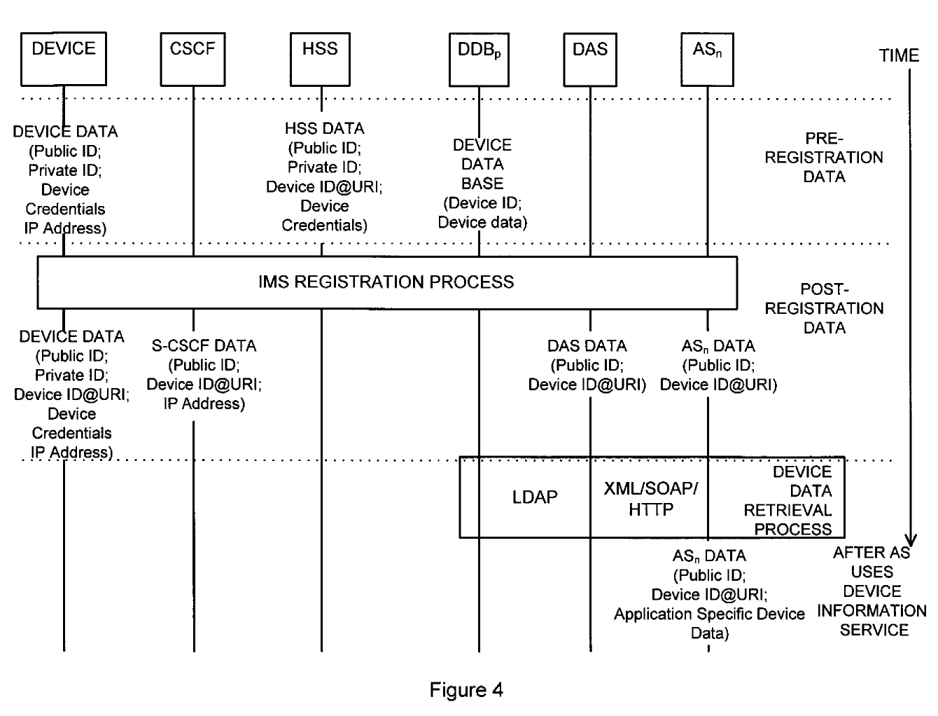

FIG. 4 is a schematic diagram illustrating a device service information process according to a particular embodiment. In general, several provisioning steps may be performed by the device information system 100 or one or more provisioning devices (not shown) when a user (e.g., customer of a service provider) subscribes to receive a service provided by a service provider. These provisioning steps may result in the transfer of data from a provisioning system or an operations support system into one or more components of the device information system 100, such as the subscriber system 110 or the end-user device 104.

As illustrated in FIG. 4, during a pre-registration process (e.g., prior to a registration process) a device (e.g., the end-user device 104), an HSS (e.g., the subscriber system 110), and the DDB (e.g., the device databases 112A, 112B, 112N) may be provisioned with data associated with the device. The device data may include a public ID, a private ID, device credentials, and an IP address associated with the device. The HSS data may include the public ID, private ID, Device_ID@URI, and device credentials associated with the device. The device database data may include the device ID and the device information associated with the device.

During a registration process, such as the IMS registration process, data may be transmitted to one or more components in the device information system 100. Accordingly, during a post-registration phase (e.g., after a registration process) the device, a CSCF (e.g., the CSCF system 108), a DAS (e.g., the DAS 102), and an ASₙ (e.g., the IMS application system 114) may receive and store data associated with the device. After the registration process, the device data may include the public ID, the private ID, device credentials, the IP address, and the Device_ID@URI associated with the device. The CSCF data may include the public ID, the Device_ID@URI, and the IP address associated with the device. The DAS data may include the public ID and the Device_ID@URI associated with the device. The ASₙ data may include the public ID and Device_ID@URI associated with the device. It should be noted that ASₙ (e.g., IMS application system 114) may have subscribed to the CSCF (e.g., the CSCF system 108) such that the ASₙ may receive data associated with the device from the CSCF during the registration process.

During the data retrieval process, the DAS may receive queries requesting device information from the ASₙ. As illustrated in FIG. 4, the ASₙ may communicate a query the DAS using any, or a combination, of a SIP method, a Hypertext Transfer Protocol (HTTP) method, and Simple Object Access Protocol HTTP (SOAP/HTTP) method (e.g., as supported by XML), and the DAS may respond to the query with the requested device information in accordance with the protocol used for communicating the query.

In response to the query, a data information service application hosted by the DAS may retrieve the requested device information using one or more database query protocols. For example, the DAS may use the Lightweight Directory Access Protocol (LDAP) to query a device database for the requested device information. After the DAS provides the requested device information to the ASₙ, the ASₙ data may include the public ID, the Device_ID@URI, and the device information associated with the device.

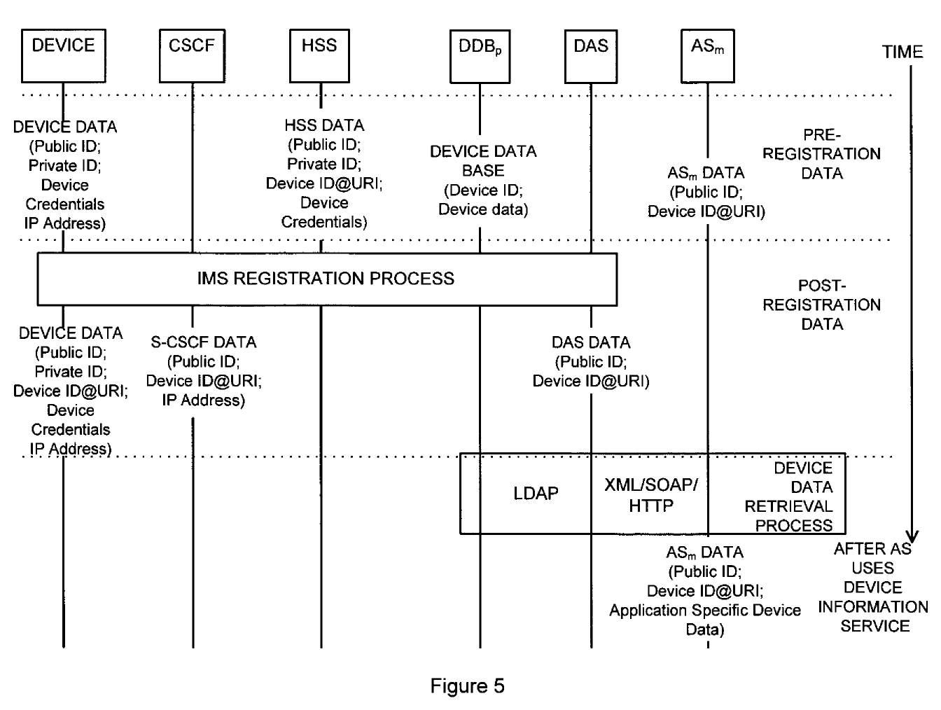

FIG. 5 is a schematic diagram illustrating another device service information process according to a particular embodiment. As previously discussed, the device information system 100 may enable applications of a non-IMS application system (e.g., non-IMS application system 116) to request and receive device information from a DAS. For example, an application of a non-IMS application system, such as the ASₘ may request device information from a DAS using queries.

Since the ASₘ is not subscribed to the IMS, the ASₘ may receive the ASₘ data from external communication sources (not shown) that are associated with the end-user device prior to a registration process. Accordingly, prior to the registration process, the ASₘ data may include a public ID and a Device_ID@URI associated with the device. The ASₘ may retrieve device information according to the same methods described above in FIG. 4 in relation to the ASₙ.

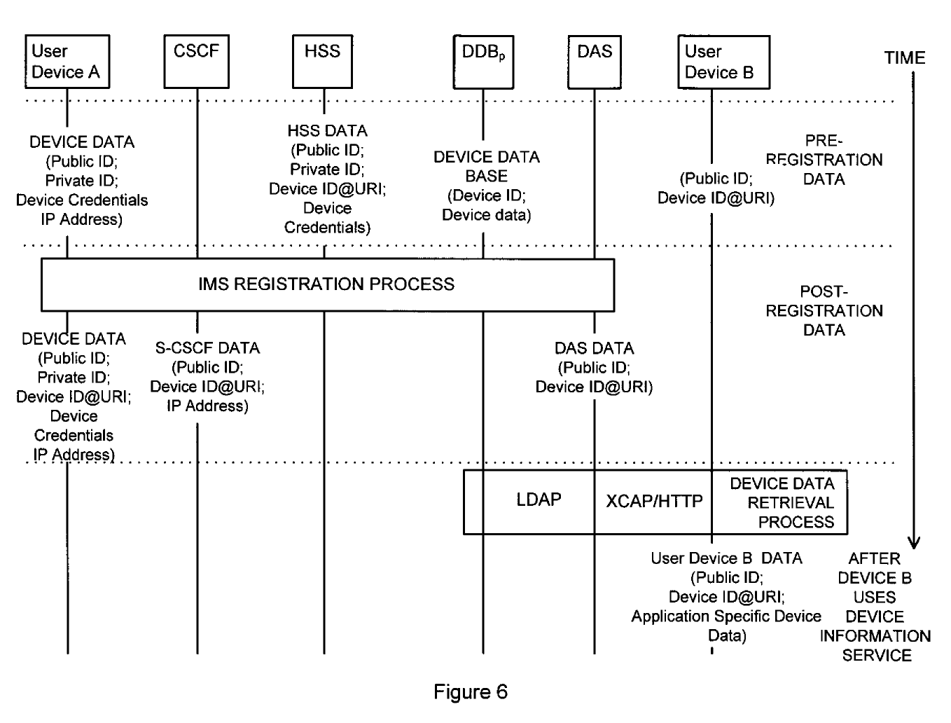

FIG. 6 is a schematic diagram illustrating another device service information process according to a particular embodiment. As illustrated in FIG. 6, an application providing a service to an end-user device may not be hosted on an IMS application system 114 or a non-IMS application system 114. In such embodiments, the application may reside on another device (e.g., a mobile device, a PSTN gateway, a MSC gateway), such as User Device B illustrated in FIG. 6. Like other applications of non-IMS application systems, User Device B may also request device information from a DAS using queries.

Since the User Device B is not subscribed to the IMS, User Device B may receive the User Device data from external communication sources (not shown) that are associated with the end-user device prior to a registration process. Accordingly, prior to the registration process, the User Device B data may include a public ID and a Device_ID @URI associated with the device. As illustrated in FIG. 6, User Device B may communicate a query to the DAS 102 using any, or a combination, of a SIP method, HTTP method, a SOAP/HTTP method (e.g., as supported by XML), and a XML Configuration Access Protocol HUP (XCAP/HTTP) method. The DAS 102 may respond to the query with the requested device information in accordance with the protocol (e.g., method) used for communicating the query.

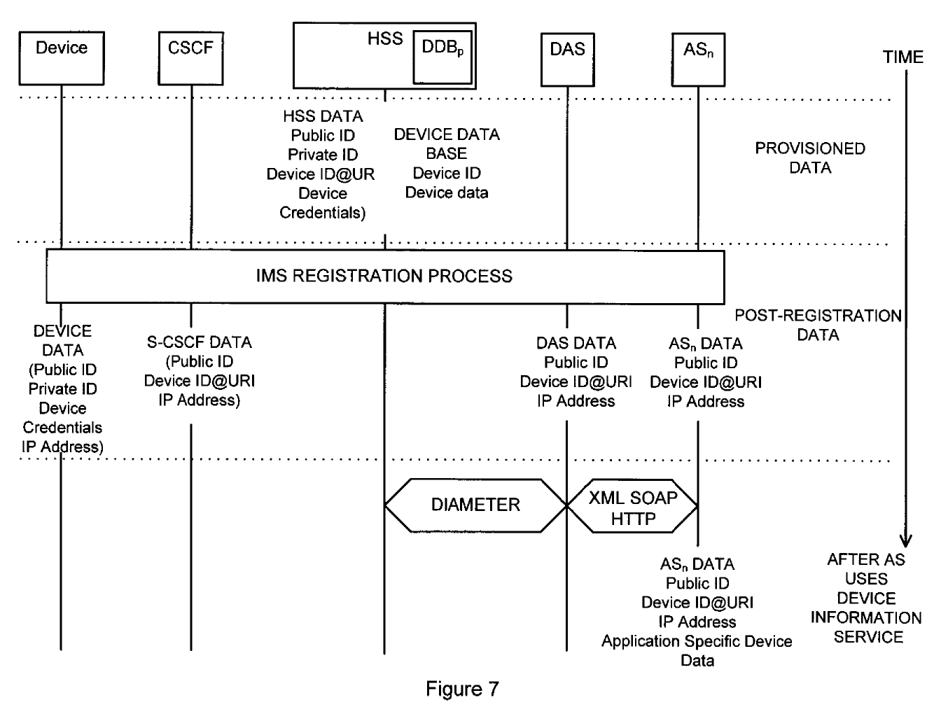

FIG. 7 is a schematic diagram illustrating another device service information process according to a particular embodiment. In one embodiment, the HSS (e.g., the subscriber system 110) may include one or more device databases (e.g., device databases 112A, 112B, 112N). Since the HSS includes one or more device databases, the DAS (e.g., DAS 102) may communicate with the device databases to retrieve requested device information using a DIAMETER protocol during the device data retrieval process.

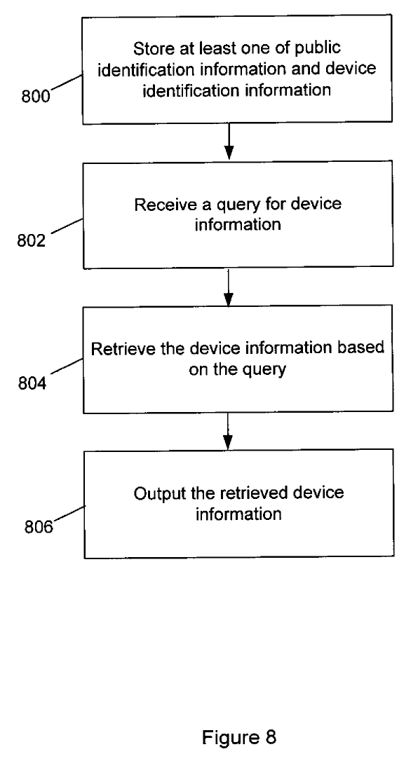

FIG. 8 is a flowchart illustrating the functionality of a particular embodiment. This exemplary method is provided by way of example, as there are a variety of ways to carry out methods disclosed herein. The method shown in FIG. 8 may be executed or otherwise performed by one or a combination of various systems. The method is described below as carried out by the DAS 102 shown in FIG. 1 by way of example, and various elements of the DAS 102 are referenced in explaining the example method of FIG. 8. Each block shown in FIG. 8 represents one or more processes, methods, or subroutines carried out in the exemplary method. Referring to FIG. 8, the exemplary method may begin at block 800.

In block 800, the method may include storing at least one of public identification information and device identification information. In one embodiment, the identification information module 200 of the DAS 102 may store at least one of public identification information and device identification associated with an end-user device. The method may continue to block 802.

In block 802, the method may include receiving a query for device information. In one embodiment, the device information query module 202 of the DAS 102 may receive a query for device information associated with the end-user device from an application system such as, the IMS application system 114 or the non-IMS application system 116. The method may continue to block 804.

In block 804, the method may include retrieving the device information based on the query. In one embodiment, the device information retrieval module 204 of the DAS 102 may retrieve the device information from one or more device databases (e.g., device database 112A, 112B, 112N) based on the query. The method may continue to block 806.

In block 806, the method may include outputting the retrieved device information. In one embodiment, the device information output module 206 of the DAS 102 may output the retrieved device information. The method may then end.

In the preceding specification, various preferred embodiments have been described with references to the accompanying drawings. It will, however, be evident that various modifications and changes may be made thereto, and additional embodiments may be implemented, without departing from the broader scope of invention as set forth in the claims that follow. The specification and drawings are accordingly to be regarded in an illustrative rather than restrictive sense.

We claim:

1. A system, comprising:
an identification information computing apparatus configured to store at least one of public identification information and device identification information associated with an end-user device;
a device information query computing apparatus configured to receive, from an application system, a query for device information associated with the end-user device via a network;
a device information retrieval computing apparatus configured to retrieve, from a device database, the device information based on the query; and
a device information output computing apparatus configured to output, to the application system, the retrieved device information.

2. The system of claim 1, wherein the identification information computing apparatus is further configured to receive, from at least one of a subscriber system and the end-user device, the public identification information and the device identification information via a network.

3. The system of claim 1, wherein the public identification information comprises data associated with an Internet Protocol Multimedia Subsystem Public User Identity (IMPU).

4. The system of claim 1, wherein the device identification information comprises a unique identifier.

5. The system of claim 1, wherein the device identification information comprises at least one of an organizationally unique identifier (OUI) and a unique serial number identifier.

6. The system of claim 1, wherein the end-user device is an authenticated end-user device that is associated with the public identification information and the device identification information.

7. The system of claim 1, wherein the device information retrieval computing apparatus is further configured to select the device database from which to retrieve the device information.

8. The system of claim 7, wherein the device information retrieval computing apparatus is further configured to select the device database based on a device type associated with the device database.

9. The system of claim 8, wherein the device type associated with the device database comprises at least one of a set top box device type, a Voice over Internet Protocol (VoIP) device type, a Personal Computer (PC) device type, an Analog Terminal Adaptor (ATA) device type, and a mobile phone device type.

10. The system of claim 7, wherein the device information retrieval computing apparatus is further configured to select the device database based on a manufacturer associated with the device database.

11. The system of claim 7, wherein the device information retrieval computing apparatus is further configured to select the device database based on a sequential search of a plurality of device databases.

12. The system of claim 7, wherein the device information retrieval computing apparatus is further configured to output, to the application system, device information from the selected device database.

13. The system of claim 1, wherein the query comprises at least the device identification information.

14. The system of claim 1, wherein the device information indicates one or more characteristics of the end-user device.

15. A method, comprising:
storing at least one of public identification information and device identification information associated with an end-user device;
receiving, from an application system, a query for device information associated with the end-user device via a network;
retrieving, from a device database, the device information based on the query; and
outputting, to the application system, the retrieved device information.

16. The method of claim 15, further comprising receiving, from at least one of a subscriber system and the end-user device, the public identification information and the device identification information via a network.

17. The method of claim 15, wherein the public identification information comprises data associated with an Internet Protocol Multimedia Subsystem Public User Identity (IMPU).

18. The method of claim 15, wherein the device identification information comprises a unique identifier.

19. The method of claim 15, wherein the device identification information comprises at least one of an organizationally unique identifier (OUI) and a unique serial number identifier.

20. The method of claim 15, wherein the end-user device is an authenticated end-user device that is associated with the public identification information and the device identification information.

21. The method of claim 15, further comprising selecting the device database from which to retrieve the device information.

22. The method of claim 21, wherein the selecting is based on a device type associated with the device database.

23. The method of claim 22, wherein the device type associated with the device database comprises at least one of a set top box device type, a Voice over Internet Protocol (VoIP) device type, a Personal Computer (PC) device type, an Analog Terminal Adaptor (ATA) device type, and a mobile phone device type.

24. The method of claim 21, wherein the selecting is based on a manufacturer associated with the device database.

25. The method of claim 21, wherein the selecting is based on a sequential search of a plurality of device databases.

26. The method of claim 21, wherein the outputting further comprises outputting, to the application system, device information from the selected device database.

27. The method of claim 15, wherein the query comprises at least the device identification information.

28. The method of claim 15, wherein the device information indicates one or more characteristics of the end-user device.

29. The method of claim 15, wherein the application system modifies a service to the end-user device based on the device information.

30. A computer readable media comprising code to perform the acts of the method of claim 15.

31. A method, comprising:
storing at least one of public identification information and device identification information associated with an end-user device;
receiving, from an application system, a query for device information associated with the end-user device via a network, wherein the query comprises at least the device identification information;
selecting a device database from which to retrieve the device information based on a device type associated with a device database;
retrieving, from the device database, the device information based on the query; and
outputting, to the application system, the retrieved device information
